(19) United States
(12) Patent Application Publication
(10) Pub. No.: US 2004/0163292 A1
(43) Pub. Date: Aug. 26, 2004

(54) Warning unit

(76) Inventor: Paul Andrew Wilson, Hockley (GB)

Correspondence Address: Edwin D Schindler, Five Hirsch Avenue, PO Box 966, Coram, NY, 11727-0966, US

(21) Appl. No.: 10/480,718

(22) PCT Filed: Jun. 5, 2002
(86) PCT No.: PCT/GB02/02539

(30) Foreign Application Priority Data
Jun. 11, 2001 (GB) 0114179.5
Dec. 6, 2001 (GB) 0129178.0

(51) Int. Cl. G09F 27/00

(52) U.S. Cl. 40/597; 40/455

(57) ABSTRACT

A warning unit includes an upright housing in which a sound emitter is disposed, along with a sensor for responding to the approach of a pedestrian to energize the sound emitter. A suction device is provided in the bottom of the warning unit for engaging the floor to retain the unit in position, the suction device having an actuating lever disposed within the housing and accessible through a normally-locked door of the housing.

The present invention relates to a warning unit and more particularly to a warning unit for use in providing a warning of an e.g. wet floor in a public building or other walkway.

It is common to place a warning device on the floor of a public building, such as a shopping centre, or of a public walkway, to warn pedestrians of an area of floor which is wet, for example, because it has been washed, or otherwise temporarily unsuitable for walking over.

I have now devised a warning unit which provides a warning of improved effectiveness to pedestrians.

In accordance with the present invention, there is provided a warning unit which comprises a structure for standing upright on the floor and including a housing in which sound emitting means are mounted, a sensor for responding to the approach of a pedestrian to energise the sound emitting means, and a suction device provided in the bottom of the unit and operable for engaging the floor to retain the unit in position, the suction device having an actuating lever disposed within said housing and accessible through a door of said housing.

Preferably the housing of the warning unit is elongate in form, the bottom of the housing standing on the floor, either directly or via a base of the unit. An upper portion of the housing may taper towards the top of the unit. The housing may be square or circular in cross-section, or of any other appropriate cross-sectional shape.

Preferably the sensor is positioned at or adjacent the top of the unit. Preferably the sound emitting means is positioned adjacent the top of the unit. Preferably the side wall or walls of the housing are formed with openings (e.g. grilles) to allow the emission of the sounds generated by the sound emitting means.

Preferably the warning unit is arranged to replay a verbal message via the sound emitting means. Preferably a facility is provided to select the verbal message which will be replayed, from a number of available messages. Preferably the unit is arranged to permit new messages to be recorded.

The warning unit may be provided with a flashing light which is energised in response to the sensor sensing the approach of a pedestrian.

An embodiment of the present invention will now be described by way of example only and with reference to the accompanying drawings, in which:

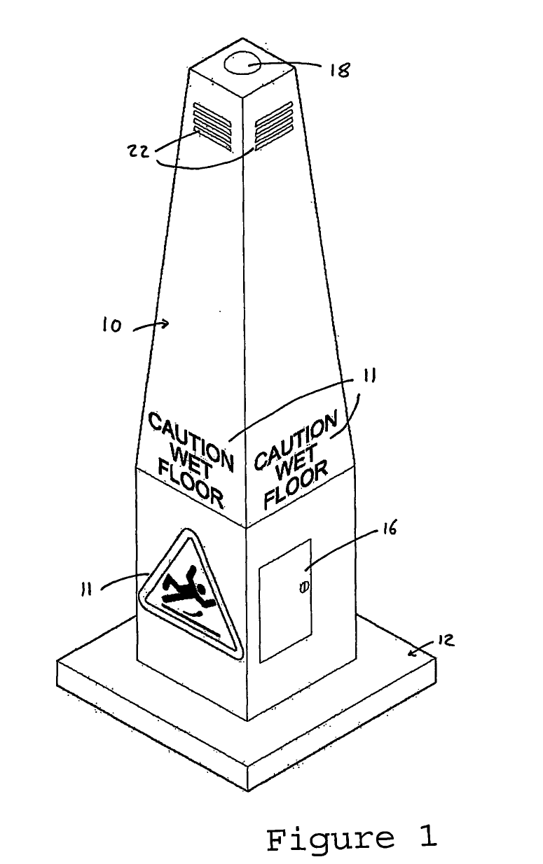

FIG. 1 is an isometric view of a warning unit in accordance with the present invention; and

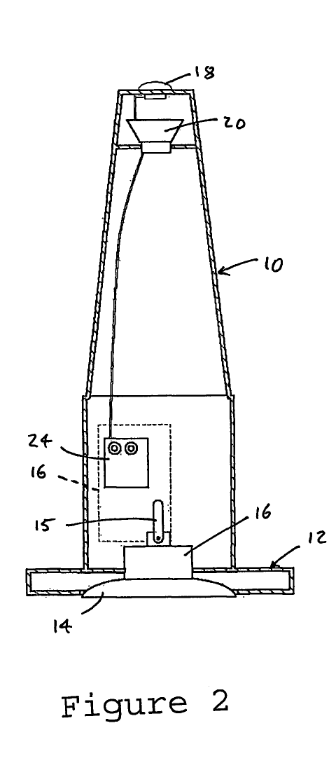

FIG. 2 is a vertical section through the warning unit shown in FIG. 1.

Referring to the drawings, there is shown a warning unit which comprises an upright, hollow housing 10 provided with a generally flat base 12, for standing upright on the floor. The housing 10 is of generally square cross-section and an upper portion tapers towards the top. The base 12 is square in shape, somewhat larger than the housing 10, and is formed integrally with the housing 10. The housing 10 and base 12 may each be of alternative shapes in plan view, e.g. circular.

A suction device is mounted in the base of the unit, and comprises a suction cup 14 for engaging the floor, the suction cup 14 being carried by a mount 16 from the top of which an actuating lever 15 projects. The lever 15 is coupled to the centre of the suction cup 14 and arranged so that, upon turning the lever, the centre of the suction cup 14 is raised in order to create a vacuum between the cup and the floor, for securing the unit to the floor: when the lever is turned in the opposite direction, the centre of the suction cup lowers in order to break the vacuum and release the unit from the floor. Access to the manually-operable lever 15 is obtained through a normally-locked door 16 in one side wall of the housing 10.

A proximity sensor 18 is mounted to the flat top of the housing 10 and a loudspeaker 20 is mounted within the housing 10 adjacent its top: the side walls of te housing 10 are formed with grilles 22 adjacent the loudspeaker 20, to allow the emission of sounds generated by the loudspeaker. A control unit 24 is mounted within the housing 10 and is accessible through the door 16.

In use the warning unit is placed in an appropriate position on the floor and secured in place by actuating the suction device via the lever 15. The unit is then switched on using an ON/OFF switch on the control unit 24, accessible through the door 16.

Should a pedestrian approach the area of floor or walkway protected by the warning unit, the proximity sensor 18 senses the pedestrian and causes the control unit 24 to play a recorded audible message, which is relayed by the loudspeaker 20. The warning unit may include a flashing light, at or adjacent its top, which is energised at the same time. The control unit 24 may be arranged to play any of a number of different messages, selected by a selector switch on the control unit 24.

It will be noted that the outside surfaces of the housing 10 carry visual warning signs and messages 11.

Although not shown in the drawings, preferably one or more tapes or other elongate flexible elements are provided, for linking between the warning unit and other structure (e.g. similar units), to form a barrier to pedestrians. In particular, the warning unit may include one or more retractable tape units from which the tapes may be extended when required.

Preferably the unit includes a movement sensor arranged to provide an audible alarm in the event that the unit is moved by an unauthorised person. The movement sensor may comprise one or more tilt switches, or a pressure switch acting between the underside of the unit and the floor. The audible alarm is preferably relayed through the loudspeaker 20.

1) A warning unit which comprises a structure for standing upright on the floor and including a housing in which sound emitting means are mounted, a sensor for responding to the approach of a pedestrian to energise the sound emitting means, and a suction device provided in the bottom of the unit and operable for engaging the floor to retain the unit in position, the suction device having an actuating lever disposed within said housing and accessible through a door of said housing.

2) A warning unit as claimed in claim 1, in which said housing is elongate in form.

3) A warning unit as claimed in claim 2, in which an upper portion of said housing tapers towards the top of the unit.

4) A warning unit as claimed in any preceding claim, in which said sensor is positioned at or adjacent the top of the unit.

5) A warning unit as claimed in any preceding claim, arranged to replay a verbal message via said sound emitting means.

6) A warning unit as claimed in claim 5, including means for selecting, from a number of available messages, the verbal message to be replayed.

7) A warning unit as claimed in claim 5 or 6, arranged for one or more new messages to be recorded for selective replay.

8) A warning unit as claimed in any preceding claim, including a flashing light which is energised in response to said sensor sensing the approach of a pedestrian.

9) A warning unit as claimed in any preceding claim, including elongate flexible elements for linking the unit to other structure to form a barrier to pedestrians.
